(19) United States
(12) Patent Application Publication
(10) Pub. No.: US 2025/0050573 A1
(43) Pub. Date: Feb. 13, 2025

(54) FILM PASTING DEVICE AND FILM PASTING METHOD

(71) Applicant: Beijing Zitiao Network Technology Co., Ltd., Beijing (CN)

(72) Inventors: Xinyou FENG, Beijing (CN); Xin ZHANG, Beijing (CN); Guanghui LIU, Beijing (CN); Jia HUANG, Beijing (CN)

(21) Appl. No.: 18/800,542

(22) Filed: Aug. 12, 2024

(30) Foreign Application Priority Data
Aug. 11, 2023 (CN) 202311014097.7

(51) Int. Cl. B29C 63/00; B29C 63/02; B29L 11/00; G02B 1/10

(52) U.S. Cl. CPC B29C 63/0073; B29C 63/0091; B29C 63/025; B29L 2011/0016; G02B 1/10

(57) ABSTRACT

The disclosure discloses a film pasting device and a film pasting method. The film pasting device comprises a first cavity, a second cavity, a flexible film layer and an illumination module, the second cavity can interface with the first cavity, the second cavity has a bearing area, the bearing area is configured to bear a lenses and a functional film material being prepositioned; the flexible film layer is disposed at the open end of the first cavity, the flexible film layer is configured to deform under the action of external force and extrude the functional film material in the bearing space, so that the functional film material is attached to the lens; the illumination module is configured to irradiate the functional film material, so that the adhesive layer between the functional film material and the lens is cured, and the functional film material is adhered and fixed with the lens.

### CROSS REFERENCE TO RELATED APPLICATIONS

The present application claims priority to Chinese Patent Application No. 202311014097.7, filed on Aug. 11, 2023 and entitled “FILM PASTING DEVICE AND FILM PASTING METHOD”, the entirety of which is incorporated herein by reference.

### FIELD

The disclosure belongs to the technical field of preparation of optical lenses, and particularly relates to a film pasting device and a film pasting method.

### BACKGROUND

With the continuous development of science and technology, extended reality (extended reality, XR) technology also gradually enters various industries. XR includes virtual reality (VR), augmented reality (AR), mixed reality (MR), and the like. Taking the VR device in the VR application scenario as an example, the user may use a VR device, for example, VR glasses, to watch a virtual reality scene.

A folding optical path (Pancake) is a great breakthrough for the optical module in VR device to realize optical lightness and thinness, and the volume of the optical module is greatly compressed through the folding of the optical path. Specifically, the Pancake is based on the folded optical path formed by a functional film material such as a quarter-wave plate, a reflective film layer, a polarizing film layer and the like and the lens, so that the optical path can be folded back for multiple times, the imaging working distance between the screen and the lens is shortened, and the length of the whole optical module is also significantly reduced. In the related art, in order to bring a larger field of view (FOV) and better imaging quality, a lens with a surface being a curved surface is usually used, which causes a greater difficulty in attaching the functional film material to the lens.

### SUMMARY

Embodiments of the disclosure provide a film pasting device and a film pasting method, and aims to solve the technical problem that the attaching difficulty of a functional film material and a lens with a curved surface in the related technology is large.

According to a first aspect, the disclosure provides a film pasting device, including:
a first cavity;
a second cavity being capable of interfacing with the first cavity and having a bearing area configured to bear a lens and a functional film material being prepositioned;
a flexible film layer disposed at an open end of the first cavity and configured to deform under an external force and extrude the functional film material, so that the functional film material is attached to the lens;
an illumination module configured to irradiate the functional film material, so that an adhesive layer between the functional film material and the lens is cured, and the functional film material is adhered and fixed to the lens.

According to a second aspect, the disclosure provides a film pasting method, including:
placing a lens and a functional film material being prepositioned in a bearing area of a second cavity of a film pasting device;
interfacing a first cavity and the second cavity of the film pasting device, so that a flexible film layer disposed at an open end of the first cavity extrudes the functional film material, so that the functional film material is attached to the lens;
turning on an illumination module of the film pasting device, so that an adhesive layer between the functional film material and the lens is cured under the irradiation of the illumination module, and the functional film material is adhered and fixed to the lens.

According to the film pasting device and the film pasting method provided by the disclosure, the first cavity, the second cavity, the flexible film layer and the illumination module are provided in the film pasting device, when the first cavity and the second cavity are interfaced, the shape of the flexible film layer located at the open end of the first cavity can be changed, the deformed flexible film layer generates an acting force and extrudes the functional film material located on the bearing area of the second cavity until the functional film material is tightly attached to the lens, then the adhesive layer between the functional film material and the lens is irradiated through the illumination module, the functional film material and the lens are reliably adhered through the curing of the adhesive layer, such that the curved surface can be attached without hot bending forming, the problems of large precision control difficulty, poor matching property of functional film material and lens surface type and the like caused by the rebound phenomenon after hot bending forming are avoided, the method is easy to realize, the product yield is improved, and the process difficulty of curved surface attaching is reduced.

### BRIEF DESCRIPTION OF DRAWINGS

In order to more clearly illustrate the technical solutions in the embodiments of the disclosure or related technologies, the accompanying drawings used in the description of the embodiments or related technologies are briefly described below, and it is obvious that the drawings in the following description are some embodiments of the disclosure, and for those of ordinary skill in the art, other drawings may be obtained based on these drawings without creative work. In the drawings:

FIG. 1 is a schematic diagram of a scenario of a film pasting device according to an embodiment of the disclosure;

FIG. 2 is a schematic cross-sectional structural diagram of a film pasting device when a first cavity and a second cavity are in an un-interfaced state according to an embodiment of the disclosure;

FIG. 3 is a schematic cross-sectional structural diagram of a film pasting device when a first cavity and a second cavity are in an interfaced state according to an embodiment of the disclosure;

FIG. 4 is a schematic diagram of an application when a film pasting device is applied to film pasting according to an embodiment of the disclosure;

FIG. 5 is a schematic structural diagram of a functional film material and an adhesive layer according to an embodiment of the disclosure;

FIG. 6 is a schematic structural diagram of a functional film material and an adhesive layer according to another embodiment of the disclosure;

FIG. 7 is a schematic cross-sectional structural diagram of a film pasting device when a first cavity and a second cavity are in an un-interfaced state according to another embodiment of the disclosure;

FIG. 8 is a schematic diagram of an application when a film pasting device according to an embodiment of the disclosure applies a film to a lens whose attaching surface is a convex surface;

FIG. 9 is a schematic cross-sectional structural diagram of a film pasting device when a first cavity and a second cavity are in an un-interfaced state according to still another embodiment of the disclosure;

FIG. 10 is a schematic structural diagram of a functional film material and a positioning film layer according to an embodiment of the disclosure;

FIG. 11 is a schematic structural diagram of a lens, a functional film material and a positioning film layer according to an embodiment of the disclosure;

FIG. 12 is a schematic structural diagram of a positioning film layer according to an embodiment of the disclosure;

FIG. 13 is a schematic diagram of a scenario of a film pasting device according to another embodiment of the disclosure;

FIG. 14 is a schematic diagram of an application when a film pasting device according to an embodiment of the disclosure applies a film to a lens whose attaching surface is a convex surface;

FIG. 15 is a schematic flowchart of a film pasting method according to an embodiment of the disclosure;

FIG. 16 is a schematic flowchart of a film pasting method according to another embodiment of the disclosure.

### REFERENCE NUMERALS INDICATE

10—first cavity; 11—first frame; 12—internal space; 13—interfaced surface; 10a—positioning hole;
20—second cavity; 21—bearing area; 22—interfaced area; 23—airflow channel; 231—air vents; 232—airflow convergence hole; 24—groove; 25—avoidance groove; 26—positioning portion;
30—flexible film layer;
40—illumination module;
50—vacuum pump;
80—lens;
90—functional film material; 91—adhesive layer; 92—positioning film layer; 92a—through hole; 921—positioning main body portion; 922—positioning lug.

### DETAILED DESCRIPTION

The following describes embodiments of the disclosure in detail, examples of which are shown in the accompanying drawings. The embodiments described below with reference to the accompanying drawings are exemplary, and are intended to be used for explaining the disclosure and should not be construed as limiting the disclosure.

Embodiments of the disclosure may be applied to an application scenario of extended reality (eXtended Reality, XR). The XR may include: virtual reality (VR), augmented reality (AR), mixed reality (MR), and the like.

First, some nouns or terms appearing in the process described in the embodiments of the disclosure are explained as follows:

Extended reality (XR) is a concept including virtual reality (VR), augmented reality (AR), and mixed reality (MR), representing an environment in which a virtual world is connected to a real world, and a technology in which a user can interaction in real time with the environment.

Virtual reality (VR), a technology for creating and experiencing a virtual world, a calculation and generation of a virtual environment is a multi-source information (the virtual reality mentioned herein includes at least visual perception, and may also include auditory perception, tactile perception, motion perception, even further including taste perception, olfactory perception, etc.), implementing simulation of a fused, interactive three-dimensional dynamic visual and physical behavior of a virtual environment, enabling a user to be immersed into a simulated virtual reality environment, and implementing an application of a plurality of virtual environments such as a map, a game, a video, an education, a medical, a simulation, a collaborative training, a sales, an assisted manufacturing, maintenance, and repair.

A virtual field of view refers to an area in a virtual environment that can be perceived by a user through a lens in a virtual reality device, and a field of view (FOV) of a virtual field of view is used to represent a perceived area.

The virtual reality device, that is, the VR device, is a terminal that achieves a virtual reality effect, and may generally be provided as a glasses, a head mount display (HMD), and a form of a contact lens, so as to realize visual perception and other forms of perception, and of course, the shape of the virtual reality device is not limited thereto, and can be further miniaturized or miniaturized as required.

The virtual reality device described in this embodiment of the disclosure may include, but is not limited to, the following types:

A computer end virtual reality (PCVR) device uses a PC end to perform related calculation and data output of a virtual reality function, and an external computer end virtual reality device uses data output by a PC end to achieve an effect of virtual reality.

The mobile virtual reality device supports setting a mobile terminal (such as a smart phone) in various manners (for example, a head-mounted display provided with a special card slot), performing related calculation of the virtual reality function by the mobile terminal by connecting with the mobile terminal in a wired or wireless manner, and outputting data to the mobile virtual reality device, for example, viewing the virtual reality video through the APP of the mobile terminal.

The integrated machine virtual reality device is provided with a processor for performing related calculation of virtual functions, so that the integrated machine virtual reality device has independent virtual reality input and output functions, does not need to be connected with a PC end or a mobile terminal, and is high in use degree of freedom.

In the related art, the optical module of the VR device generally includes a lens, a quarter-wave plate, a reflective film layer, a polarizing film layer and other functional film material, and the functional film material is attached to the surface of the lens. In the attaching process of the functional film material and the lens, the use of flat film pasting layer process would sacrifice part of the optical performance and the imaging quality. As the requirements of the user on the use experience become higher and higher, the lens and the curved surface film pasting layer process with the surface being the curved surface are gradually started to bring greater FOV and better imaging quality, but the difficulty of the curved surface film pasting layer process is relatively high.

In the related art of the process of some curved surface film pasting layers, the functional film materials such as the quarter-wave plate, the reflective film layer, the polarizing film layer and the like are attached to the surface of the lens, and after being attached, the functional film material and the lens are subjected to integral hot bending forming by using the mold to achieve the film material curved surface attached effect. The difficulty of the above process of the curved surface film pasting layer is that after hot bending forming, there is a rebound phenomenon, and the dimensional accuracy control difficulty is large; after the thickness of the lens exceeds a certain thickness, the hot bending forming yield is low, and even hot bending forming cannot be achieved; and hot bending forming of complex shapes, such as bending of aspheric shapes, cannot be achieved.

In the related art of the other curved surface film pasting layer process, at least one film material in the functional film material is firstly cut out of the required size, and then the film material monomer is subjected to hot bending forming by using a mold, so that the shape of the film material monomer after hot bending is close to the shape of the lens, and finally the film material monomer is attached to the surface of the lens. The difficulty of the above process of the curved surface film pasting layer is as follows: since the functional film material has a small stiffness, there is an obvious rebound phenomenon after hot bending forming, resulting in poor matching property between the functional film material and the lens surface, and it is very likely that the edge is warped or wrinkled after being attached, which will further cause the optical axis change of the optical module to affect the optical performance.

In order to overcome at least one of the above problems, in the pasting device and the attaching method provided in this embodiment, when the first cavity and the second cavity are interfaced, the flexible film layer located at the open end of the first cavity can deform based on the surface shape of the lens, the deformed flexible film layer will generate a force and act on the functional film material located on the bearing area of the second cavity, the functional film material is extruded so that the functional film material is tightly attached to the lens, after the extrusion for a preset time, the adhesive layer between the functional film material and the lens is irradiated through the illumination module, the functional film material and the lens are reliably adhered through the curing of the adhesive layer, the curved surface can be attached without hot bending forming, the problems of large precision control difficulty, poor matching property of functional film material and lens surface type and the like caused by the rebound phenomenon after hot bending forming are avoided, the method is easy to realize, the product yield is improved, and the process difficulty of curved surface attaching is reduced.

The technical solutions of the disclosure and how the technical solutions of the disclosure solve the above-mentioned problems are described in detail below with reference to specific embodiments. The following several specific embodiments may be combined with each other, and the same or similar concepts or processes may not be repeated in some embodiments. Embodiments of the disclosure are described below with reference to the accompanying drawings.

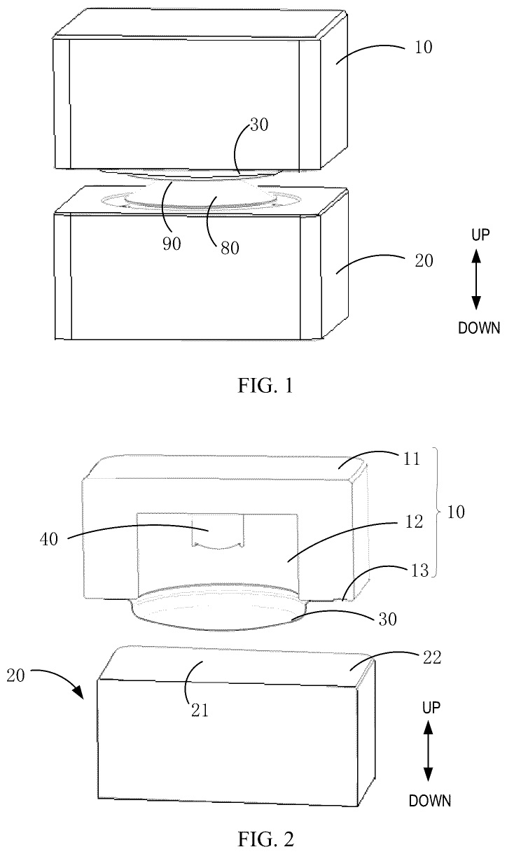

Referring to FIG. 1 to FIG. 6, the film pasting device provided in this embodiment includes a first cavity 10, a second cavity 20, a flexible film layer 30, and an illumination module 40. The second cavity 20 can interface with the first cavity 10, the second cavity 20 has a bearing area 21, and the bearing area 21 is configured to bear the lens 80 and the functional film material 90 being prepositioned. The flexible film layer 30 is disposed at the open end of the first cavity 10, and the flexible film layer 30 is configured to deform under an external force and extrude the functional film material 90 in the bearing space, so that the functional film material 90 is attached to the lens 80. The illumination module 40 is configured to irradiate the functional film material 90, so that the adhesive layer 91 between the functional film material 90 and the lens 80 is cured, and the functional film material 90 is adhered and fixed to the lens 80.

For example, as shown in FIG. 2, the first cavity 10 has a first frame 11 and an inner space 12 defined by the first frame 11. The internal space 12 defined by the first frame 11 can be used to accommodate other structures such as the illumination module 40. The specific shape and the specific size of the internal space 12 defined by the first frame 11 may be set according to actual needs. For example, the first frame 11 is substantially prismatic or cylindrical, and the internal space 12 defined by the first frame 11 may also be substantially prismatic or cylindrical.

The first cavity 10 has an open end facing the interfaced second cavity 20. The end surface of the open end of the first cavity 10 may constitute the interfaced surface 13 of the first cavity 10. The second cavity 20 has an end surface facing the interfaced first cavity 10, the end surface has a interfaced area 22 located at a periphery of the bearing area 21, and a portion of the second cavity 20 located in the interfaced area 22 can match with the interfaced surface 13.

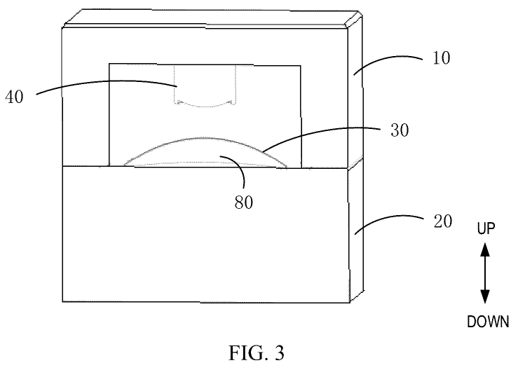

In this embodiment, the second cavity 20 and the first cavity 10 have two states, as shown in FIG. 2, one state is a separated state in which the second cavity 20 and the first cavity 10 are separated from each other, that is, an un-interfaced state; as shown in FIG. 3, the other state is an interfaced state where the second cavity 20 and the first cavity 10 are interfaced in place. The process of interfacing the second cavity 20 with the first cavity 10 may also be referred to as a mold closing process, and the interfaced state may also be referred to as a mold closing state.

For ease of description, an example in which the second cavity 20 in the interfaced state and the first cavity 10 are disposed up and down is used for description in this embodiment, and the second cavity 20 is specifically located below the first cavity 10 as an example.

The second cavity 20 is in a seat shape. The specific shape and the specific size of the second cavity 20 may be set according to actual needs, and in general, the shape of the second cavity 20 matches with the shape of the first frame 11. For example, when the first frame 11 is prismatic, the second cavity 20 is prismatic; when the first frame 11 is cylindrical, the second cavity 20 is cylindrical.

The second cavity 20 has a bearing area 21 for supporting the lens 80 and the functional film material 90 being prepositioned. For example, the bearing area 21 may include a region where an orthographic projection of the lens 80 and the functional film material 90 being prepositioned on the upper end surface of the second cavity 20 is located.

As shown in FIG. 3, in the interfaced state, the second cavity 20 can jointly enclose a bearing space with the flexible film layer 30 arranged at the open end of the first cavity 10, and the lens 80 and the functional film material 90 beared by the bearing area 21 are located in the bearing space. The flexible film layer 30 may be made of a transparent material, and the flexible film layer 30 has a relatively high toughness and is air impermeable. The flexible film layer 30 may be fixedly connected to the first cavity 10 in a fixed connection manner such as adhering, so as to isolate the bearing space from the space above the flexible film layer 30.

In some examples, when the first cavity 10 and the second cavity 20 are in an interfaced state, a portion of the flexible film layer 30 is sandwiched between the interfaced surface 13 of the first cavity and the interfaced area 22 of the second cavity. The flexible film layer 30 may be fixedly connected to the interfaced surface 13 of the first cavity. An outer edge of the flexible film layer 30 may be flush with an outer edge of the interfaced surface 13 of the first cavity facing away from the inner space 12, or an outer edge of the flexible film layer 30 is located on an inner side of an outer edge of the interfaced surface 13 of the first cavity. In this way, the flexible film layer 30 can also play a sealing role, so as to prevent the bearing space from communicated with the external space through the gap between the interfaced surface 13 of the first cavity and the interfaced area 22 of the second cavity. In other examples, the flexible film layer 30 may also be fixedly connected to the inner wall of the first cavity 10.

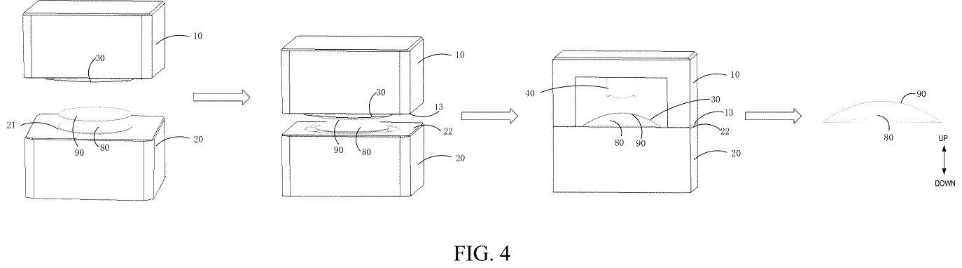

FIG. 4 is a schematic diagram of an application when a film pasting device is applied to film pasting according to an embodiment of the disclosure. The two figures on the left side in FIG. 4 are schematic diagrams of three-dimensional structures, and the two figures on the right side in FIG. 4 are schematic diagrams of cross sections. The film pasting process is described below with reference to FIG. 4.

As shown in the first figure on the left side in FIG. 4, before the first cavity 10 and the second cavity 20 are interfaced, the lens 80 and the functional film material 90 being prepositioned are disposed on the bearing area 21 of the second cavity 20, and the functional film material 90 is located on the upper side of the lens 80. The flexible film layer 30 at the open end of the first cavity 10 is in a free state, and when the flexible film layer 30 is in a free state, or the flexible film layer 30 is substantially curved shape recessed downward. In other examples, the flexible membrane layer 30 is substantially planar shape.

As shown in the second figure and the third figure on the left side in FIG. 4, during the interfacing process of the first cavity 10 and the second cavity 20, the first cavity 10 is placed above the second cavity 20, such that the first cavity 10 and the second cavity 20 are opposite to each other, and at least one of the first cavity 10 and the second cavity 20 is moved so that the distance between the first cavity 10 and the second cavity 20 gradually decreases until the interfaced surface 13 of the first cavity is matched with the interfaced area 22 of the second cavity and interfaced in place.

In the above interfacing process, the flexible film layer 30 can deform under the action of external force, and the acting force generated by deformation can act on the functional film material 90 to extrude the functional film material 90, as shown in the two figures on the right side in FIG. 4, so that the functional film material 90 gradually becomes a curved surface matched with the attaching surface of the lens 80. The external force applied to the flexible film layer 30 may be an acting force applied by the lens 80 and the functional film material 90, or may be an acting force generated by a pressure difference between the upper side and the lower side of the flexible film layer 30, or may be a acting force applied by another structural component.

When the attaching surface of the lens 80 is a convex surface protruding toward the functional film material 90, in the functional film material 90 and the lens 80 being prepositioned, as shown in the first figure on the left side in FIG. 4, the edge of the functional film material 90 is in a tilted state with respect to the lens 80. During the interfacing process, as shown in the second figure and the third figure on the left side in FIG. 4, when the distance between the first cavity 10 and the second cavity 20 is reduced to a certain degree, the flexible film layer 30 can be in contact with the functional film material 90 on the upper side of the lens 80, and as the distance between the first cavity 10 and the second cavity 20 continues to decrease, the flexible film layer 30 can deform under the action of the lens 80 and the functional film material 90 and generate an acting force acting on the functional film material 90 to extrude the functional film material 90, as shown in the two figures on the right side in FIG. 4, so that the functional film material 90 gradually becomes a convex surface matched with the attaching surface of the lens 80 until the functional film material 90 is completely attached to the lens 80.

When the attaching surface of the lens 80 is a concave surface recessed away from the functional film material 90 (not shown in the figure), after interfaced in place, the flexible film layer 30 can deform under the acting force generated by the difference between the upper pressure and the lower pressure or the acting force applied by other structural components and generate an acting force acting on the functional film material 90 to extrude the functional film material 90, so that the functional film material 90 gradually becomes a concave surface matched with the attaching surface of the lens 80 until the functional film material 90 is completely attached to the lens 80.

After the functional film material 90 and the lens 80 are attached and the flexible film layer 30 is extruded for a certain time, the illumination module 40 may be turned on, so that the light emitted by the illumination module 40 can irradiate the photoinitiator in the adhesive layer 91, so that the adhesive layer 91 is cured, and the functional film material 90 is adhered and fixed with the lens 80.

The illumination module 40 is disposed within the first cavity 10 or disposed within the second cavity 20, which facilitates the light emitted by the illumination module 40 to irradiate the adhesive layer 91. The illumination module 40 may be located above or below the bearing area 21, and the illumination module 40 may be specifically located above or below the center of the bearing area 21. For example, as shown in FIG. 2 and FIG. 3, the illumination module 40 is disposed on an inner wall of the first cavity 10 and located in a central region of the upper inner wall, so that the illumination module 40 may be located above the center of the bearing space.

In some examples, the irradiation area of the illumination module 40 at least covers the bearing area 21, which facilitates the comprehensive coverage of the adhesive layer 91, so that the adhesive layer 91 can be cured everywhere. The bearing area 21 is a region where an orthographic projection of the functional film material 90 and the lens 80 on the end surface of the second cavity 20 facing the first cavity 10 is located.

In some examples, the illumination module 40 includes an ultraviolet light illumination module. The adhesive layer 91 of the bearing area 21 includes at least one of the following: a transparent photoinitiator and acrylic acid. The transparent photoinitiator includes, but is not limited to, 2-hydroxy-2-methyl-1-phenyl acetone, methyl benzoylformate. The acrylic acid may also be replaced by other materials comprising a carbon-carbon double bond component or an epoxy component. In this way, after the ultraviolet light with the wavelength of 250-400 nm is irradiated to the transparent photoinitiator, free radicals and carbon-carbon double bonds or epoxy reaction curing are generated in the adhesive layer 91, so that the cured adhesive layer 91 reliably adhere the functional film material 90 and the lens 80. In other examples, the illumination module 40 may also use light of other wavelength bands to the corresponding transparent photoinitiator and generate a corresponding reaction curing.

In this embodiment, the functional film material 90 includes at least one of the following: a polarizing film layer, a reflective film layer, and a quarter-wave plate.

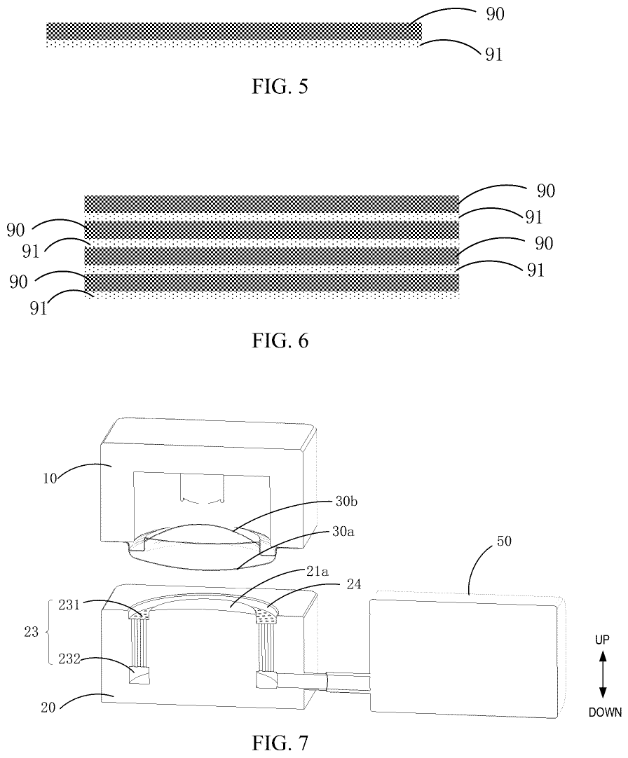

In the lens 80 and the functional film material 90 being prepositioned, as shown in FIG. 5, when there is one functional film material 90, the functional film material 90 has an adhesive surface facing the lens 80, the lens 80 has an attaching surface facing the functional film material 90, and an adhesive surface of the functional film material 90 is provided with an adhesive layer 91. The adhesive layer 91 includes a photoinitiator, so that the adhesive layer 91 can be cured under light irradiation, and the functional film material 90 is adhered and fixed with the lens 80.

In the lens 80 and the functional film material 90 being prepositioned, as shown in FIG. 6, when there are a plurality of functional film materials 90, the surface of the functional film material 90 facing the adjacent film material is also an adhesive surface, the adhesive surface is also provided with an adhesive layer 91 including a photoinitiator, so that two adjacent functional film materials 90 can be adhered and fixed by the adhesive layer 91, and the functional film material 90 adjacent to the lens 80 can also be adhered and fixed with the lens 80 through the adhesive layer 91.

According to the film pasting device provided by the embodiment, the first cavity 10, the second cavity 20, the flexible film layer 30 and illumination module 40 are arranged; the second cavity 20 can be in interfaced with the first cavity 10, the second cavity 20 has the bearing area 21, and the bearing area 21 is configured to bear the lens 80 the functional film material 90 being prepositioned; the flexible film layer 30 are arranged at the open end of the first cavity 10, and the flexible film layer 30 is configured to deform under the action of external force and extrude the functional film material 90 in the bearing space, so that the functional film material 90 is attached to the lens 80; the bearing area 21 illumination module 40 irradiates the functional film material 90, the adhesive layer 91 between the functional film material 90 and the lens 80 is cured, and the functional film material 90 is adhered and fixed with the lens 80. Therefore, the curved surface film pasting layer can be achieved without hot bending forming, the problems of large precision control difficulty, poor matching property the functional film material 90 and the lens 80 surface type caused by the rebound phenomenon after hot bending forming are avoided, the method is easy to implement, the product yield is improved, and the process difficulty of curved surface attaching is reduced.

FIG. 7 is a schematic cross-sectional structural diagram of a film pasting device when a first cavity and a second cavity are in an un-interfaced state according to another embodiment of the disclosure. Wherein, 30a in FIG. 7 is used to illustrate the flexible film layer 30 in a free state and 30b is used to illustrate the flexible film layer 30 in a deformed state.

Referring to FIG. 7, in some embodiments, the second cavity 20 is provided with an airflow channel 23, and the airflow channel 23 is communicated with the bearing space. The bearing area 21 film pasting device further comprises a vacuum pump 50, the vacuum pump 50 is communicated with the airflow channel 23, and the vacuum pump 50 is configured to vacuumize the bearing space.

For example, the airflow channel 23 includes air vents 231 and an airflow convergence hole 232, and the air vents 231 are configured to communicate the bearing space with the airflow convergence hole 232. The air vents 231 may extend in the up-down direction, that is, the axial direction of the air vents 231 is parallel to the up-down direction. The air vents 231 may have a plurality of air vents 231 uniformly distributed to facilitate uniformity of air pressure in the bearing space. For example, the plurality of air vents 231 may be in a lattice type distribution. For another example, the plurality of air vents 231 are distributed along a preset circumference and may specifically be evenly distributed along one or more circles. In this example, the specific number of the air vents 231 is not specifically limited, and the distribution manner of the air vents 231 is not limited thereto, as long as the airflow in the bearing space can be derived.

The airflow convergence hole 232 may be disposed at a lower end of the air vents 231, and the airflow convergence hole 232 is configured to converge and guide the airflow out of respective air vent 231 to the vacuum pump 50. The specific shape of the airflow convergence hole 232 may be set according to actual needs, which is not limited in this embodiment. For example, when the air vents 231 are distributed along the circumference, the airflow convergence hole 232 may include a first segment and a second segment that communicate with each other, the first segment is annular, the first segment is located at the lower end of respective air vent 231, and the second segment is configured to communicate the first segment with the vacuum pump 50.

The specific position of the second segment of the airflow convergence hole 232 may be set according to the relative positions of the vacuum pump 50 and the second cavity 20. For example, when the vacuum pump 50 is located at the side of the second cavity 20, the axial direction of the second segment may be perpendicular to the up-down direction. For another example, when the vacuum pump 50 is located below the second cavity 20, the axial direction of the second segment may be parallel to the up-down direction.

The specific shape of the second segment of the airflow convergence hole 232 may be set according to the shape of the interface of the vacuum pump 50. For example, when the interface of the vacuum pump 50 is circular, the second segment of the airflow convergence hole 232 is also set to be circular. In some examples, the interface of the vacuum pump 50 may be inserted into the second segment of the airflow convergence hole 232, or the second segment of the airflow convergence hole 232 may be communicated with the vacuum pump 50 through a pipeline. In some other examples, the outer wall of the second cavity 20 is connected with an extension ring, the second segment of the airflow convergence hole 232 extends into the extension ring, and the extension ring is inserted into the interface of the vacuum pump 50.

In some examples, the second cavity 20 is further provided with a groove 24 communicated with the bearing space, the groove 24 is recessed in a direction away from the interfaced first cavity 10, and at least part of the groove 24 is located at a periphery of the bearing area 21. For example, the groove 24 is located at a periphery of the bearing area 21, and a notch of the groove 24 is located in the bearing space.

Specifically, one end of the airflow channel 23 is located in the groove 24, or the air vents 231 of the airflow channel 23 communicates with the groove 24. The shape of the groove 24 may matches with the distribution of the air vents 231. For example, when the air vents 231 are distributed along the preset circumference, the grooves 24 may have a circular ring shape.

In this example, by providing the groove 24 and communicating the air vents 231 of the airflow channel 23 with the groove 24, it is possible to provide a space for airflow in the bearing space when vacuumizing, which is beneficial to ensuring the effect of vacuumizing.

In addition, by providing the groove 24, when the lens 80 and the functional film material 90 being prepositioned are placed into the bearing area 21, the lens 80 and the functional film material 90 cannot cover the groove 24 so as not to shield the air vents 231, and therefore, the groove 24 can prompt the placement position of the lens 80 and the functional film material 90 on the bearing area 21.

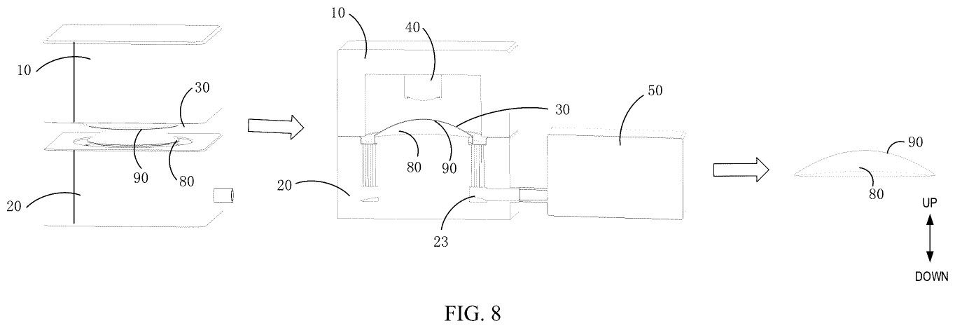

FIG. 8 is a schematic diagram of an application when a film pasting device according to an embodiment of the disclosure applies a film to a lens whose attaching surface is a convex surface. In FIG. 8, the first figure on the left side in FIG. 8 is schematic diagram of three-dimensional structures, and the two figures on the right side in FIG. 8 are schematic diagrams of cross sections. The film pasting process is described below with reference to FIG. 8.

In this embodiment, when the attaching surface of the lens 80 is a convex surface protruding toward the functional film material 90, as shown in the first figure on the left side in FIG. 8, during the interfacing process of the first cavity 10 and the second cavity 20, when the distance between the first cavity 10 and the second cavity 20 decreases to a certain extent, the flexible film layer 30 can make contact with the functional film material 90 on the upper side of the lens 80, as the distance between the first cavity 10 and the second cavity 20 continues to decrease, the flexible film layer 30 can deform under the action of the lens 80 and the functional film material 90 and generate an acting force acting on the functional film material 90 to extrude the functional film material 90, so that the functional film material 90 gradually becomes a convex surface matched with the attaching surface of the lens 80. As shown in the second figure on the left side in FIG. 8, after the first cavity 10 and the second cavity 20 are interfaced in place, the vacuum pump 50 is controlled to turn on and vacuumize the bearing space enclosed by the flexible film layer 30 and the second cavity 20 through the airflow channel 23, so that a pressure difference is formed between the space above the flexible film layer 30 and the space below the flexible film layer 30, so that the flexible film layer 30 contracts and further extrudes the functional film material 90, and the air between the functional film material 90 and the lens 80 is discharged, as shown in the rightmost figure in FIG. 8, so that the functional film material 90 is tightly attached to the lens 80, and the problem of wrinkling of the film material and warping of the film material edge can be further improved.

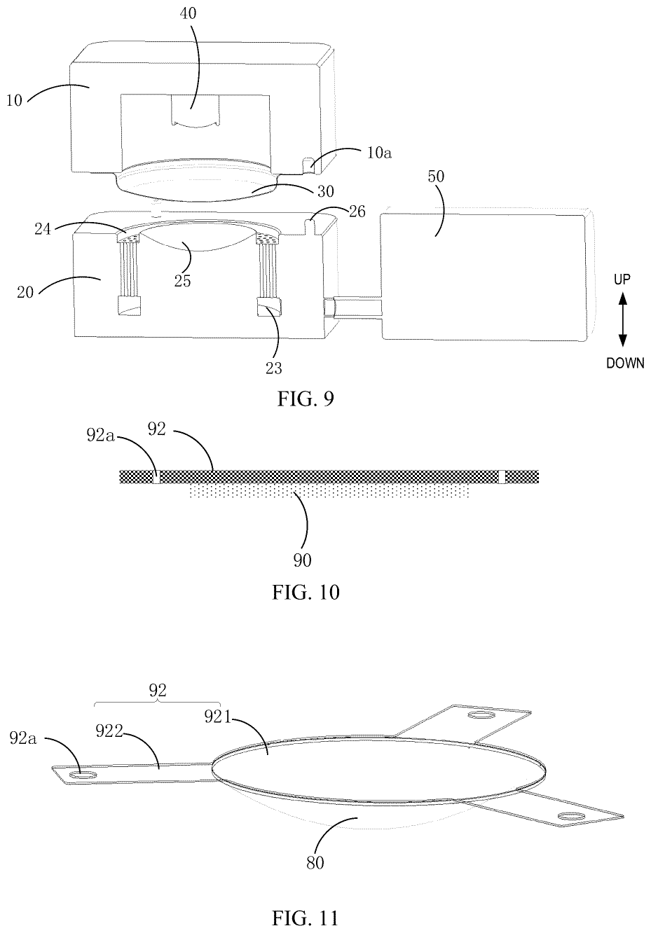

Referring to FIG. 9, in some embodiments, when the attaching surface of the lens 80 is a concave surface recessed away from the functional film material 90, an end of the second cavity 20 facing the first cavity 10 is provided with an avoidance groove 25, the avoidance groove 25 is at least partially located in the bearing area 21, and the shape of the avoidance groove 25 matches with the shape of the attaching surface of the lens 80, so that the lens 80 and the functional film material 90 can be reliably positioned, which is beneficial to ensuring the film pasting layer effect. For example, the avoidance groove 25 is located in the bearing area 21, or the portion of the second cavity 20 located in the bearing area 21 is provided with the avoidance groove 25, so that the lens 80 and the functional film material 90 disposed in the avoidance groove 25 shield the airflow channel 23 at the periphery of the bearing area 21.

Referring to FIG. 10, in some examples, a side of the functional film material 90 facing away from the lens 80 is provided with a positioning film layer 92, and a ductility of bearing area 21 and the positioning film layer 92 is higher than a ductility of the functional film material 90. The positioning film layer 92 is configured to further positioning the lens 80 and the functional film into the bearing space.

The positioning film layer 92 and the functional film material 90 may be adhered and fixed, and after the functional film material 90 and the lens 80 are adhered and fixed, the positioning film layer 92 needs to be removed from the functional film material 90. The adhesive material between the positioning film layer 92 and the functional film material 90 may be different from the material used for the adhesive layer 91. The adhesive material between the positioning film layer 92 and the functional film material 90 needs to adhere and fix the positioning film layer 92 and the functional film material 90, and after the adhesive layer 91 is cured to adhere and fix the functional film material 90 and the lens 80, it is convenient to remove the positioning film layer 92 from the functional film material 90. In addition, when there are a plurality of functional film materials 90, a side of the functional film material 90 farthest from the lens 80 and on the side of the functional film material 90 facing away from the lens 80 is provided with a positioning film layer 92.

The positioning film layer 92 may be specifically composed of release paper. The positioning film layer 92 may be made of a transparent material and has a ductility higher than that of the functional film material 90. In this way, since the ductility of the positioning film layer 92 is relatively large, in the process of changing the functional film material 90 from a planar shape to a curved surface, the positioning film layer 92 may deform before the functional film material 90, thereby reducing the stretching amount of the functional film material 90.

The thickness of the positioning film layer 92 may be greater than or equal to 0.1 mm and less than or equal to 0.2 mm. The size of the positioning film layer 92 may be greater than size of the functional film material 90, which facilitates the positioning film layer 92 to match with the second cavity 20.

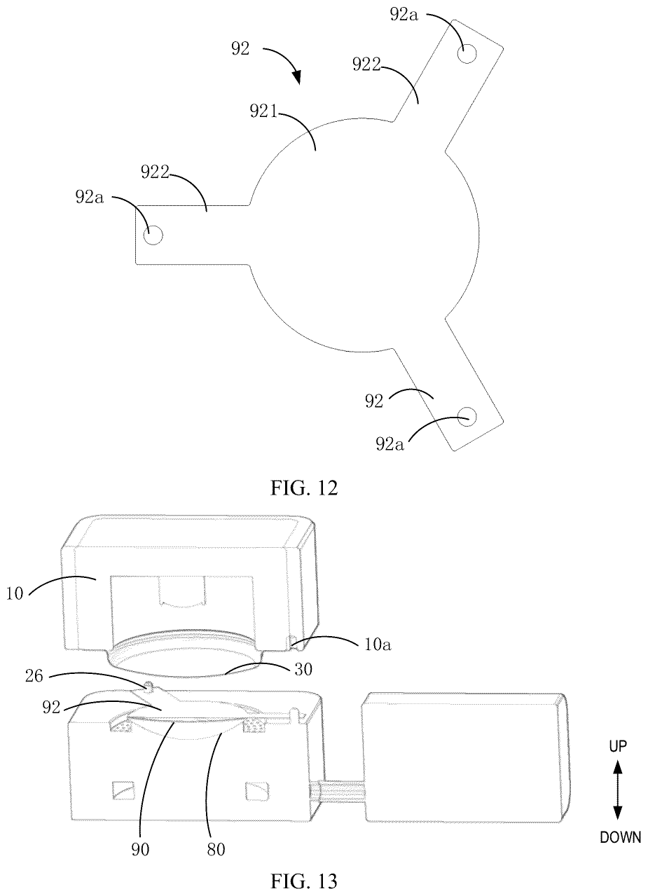

Referring to FIG. 11 and FIG. 12, for example, the positioning film layer 92 may include a positioning main body portion 921 and a positioning lug 922 connected to each other. The shape and size of the positioning main body portion 921 may match with the shape and size of the functional film material 90. For example, when the functional film material 90 is circular, the positioning main body portion 921 is also circular, and the diameter of the positioning main body portion 921 may be equal to the diameter of the functional film material 90.

The positioning lug 922 may include one or more positioning lugs 922. When there are a plurality of positioning lugs 922, the positioning effect on the functional film material 90 is better, and this embodiment will be described as an example. The plurality of positioning lugs 922 are spaced and evenly distributed along the outer circumference of the positioning main body portion 921. A through hole 92a is formed in the positioning lug 922. 92a is configured to fix the positioning film layer 92 with the second cavity 20.

In other examples, the positioning film layer 92 may include a positioning main body portion 921, a shape of the positioning main body portion 921 may match with a shape of the functional film material 90, and a size of the positioning main body portion 921 is greater than a size of the functional film material 90. For example, when the functional film material 90 is circular, the positioning main body portion 921 is also circular, and the diameter of the positioning main body portion 921 may be greater than the diameter of the functional film material 90. In this way, a portion of the positioning main body portion 921 can extend out of the functional film material 90, and a portion of the positioning main body portion 921 extending out of the functional film material 90 can be provided with a through hole 92a.

As shown in FIG. 9 and FIG. 13, an end of the second cavity 20 facing the first cavity 10 is provided with at least one positioning portion 26, and the positioning portion 26 may be located in the interfaced area 22. The shape of the positioning portion 26 match with the shape of the through hole 92a provided in the positioning film layer 92, the number of the positioning portions 26 may be equal to the number of the through holes 92a provided in the positioning film layer 92, and the distribution of the positioning portion 26 also match with the distribution of the through hole 92a.

For example, the positioning portion 26 may be columnar. For example, the positioning portion 26 may be cylindrical, and the through hole 92a provided in the positioning film layer 92 may be a round hole. For another example, the positioning portion 26 may be a prism, and the through hole 92a provided in the positioning film layer 92 may be a polygonal hole. In other examples, the positioning portion 26 may also be conical or hemispherical. In addition, the size of the positioning portion 26 may be set according to actual needs, taking the cylindrical shape of the positioning portion 26 as an example, and the diameter of the positioning portion 26 may be slightly smaller than the diameter of the through hole 92a, so that the positioning portion 26 smoothly mates with the through hole 92a.

The positioning portion 26 has at least 3, and size of the positioning portion 26 along the up-down direction thereof may be greater than or equal to 0.5 mm to facilitate ensuring the positioning reliability.

The interfaced surface 13 of the first cavity 10 facing the second cavity 20 is provided with a positioning hole 10a matched with the positioning portion 26 of the bearing area 21, so that when the second cavity 20 is interfaced with the first cavity 10, the positioning portion 26 can be inserted into the positioning hole 10a, so that a gap exists between the first cavity 10 and the second cavity 20 to affect the vacuumizing effect on the bearing space. The shape of the positioning hole 10a matches with the shape of the positioning portion 26, the number of the positioning holes 10a may be equal to the number of the positioning portions 26, and the distribution of the positioning holes 10a also matches with the distribution of the positioning portion 26.

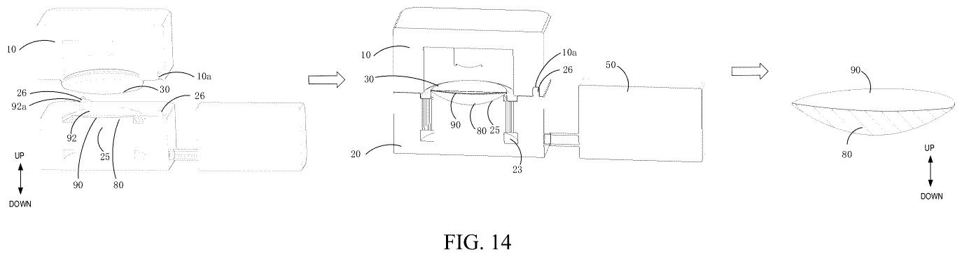

FIG. 14 is a schematic diagram of an application when a film pasting device according to an embodiment of the disclosure applies a film to a lens 80 whose attaching surface is a convex surface. Each of the sub-figures is a cross-sectional schematic diagram.

When the attaching surface of the lens 80 is a concave surface recessed away from the functional film material 90, the positioning film layer 92, the functional film material 90 and the lens 80 need to be positioned first; as shown in the first figure on the left side of FIG. 14, the positioned lens 80, the functional film material 90 and the positioning film layer 92 are placed in the bearing space, such that the lens 80 is located in the avoiding groove 25, so that the positioning portion 26 on the second cavity 20 matches with the through hole 92a on the positioning film layer 92; and then the first cavity 10 is interfaced with the second cavity 20, as shown in the second figure on the left side of FIG. 14, the positioning portion 26 on the second cavity 20 matches with the positioning hole 10a on the first cavity 10.

After the first cavity 10 and the second cavity 20 are interfaced in place, the vacuum pump 50 is controlled to turn on and vacuumize the bearing space enclosed by the flexible film layer 30 and the second cavity 20, so that a pressure difference is formed between the space above the flexible film layer 30 and the space below the flexible film layer 30, the flexible film layer 30 will shrink and extrude the functional film material 90, and the air between the functional film material 90 and the lens 80 is discharged, so that the functional film material 90 gradually becomes a concave surface matched with the attaching surface of the lens 80 until the functional film material 90 is tightly attached to the lens 80, and the problem that the film material is wrinkled and the film material edge is warped can be effectively solved. After the pressure is maintained for a certain time, the illumination module 40 is controlled to be turned on and irradiate to react the photoinitiator in the adhesive layer 91 (shown in FIG. 5 or FIG. 6), and the functional film material 90 is adhered and fixed with the lens 80. Finally, the positioning film layer 92 is removed from the functional film material 90.

This embodiment further provides a film pasting method, which may be implemented based on the film pasting device provided in the foregoing embodiment. The specific structure and function of the film pasting device are not described herein again. In addition, the implementation process of this embodiment is similar to the foregoing embodiment, and the similar details are not described herein again.

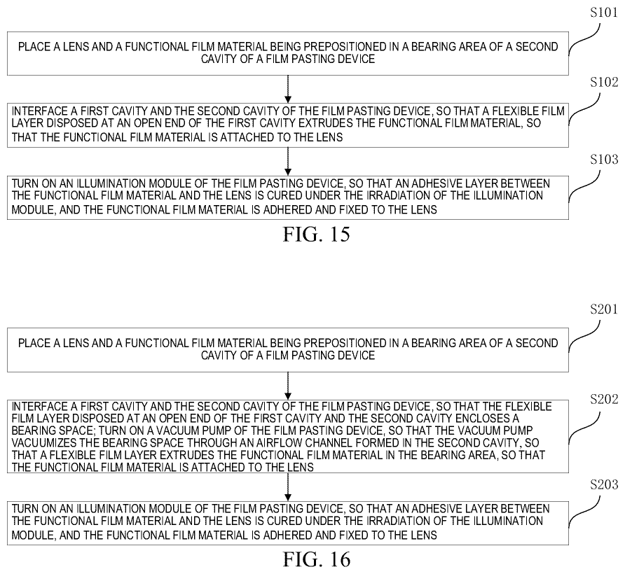

Referring to FIG. 15, the film pasting method provided in this embodiment includes the following steps.

S101, place a lens and a functional film material being prepositioned in a bearing area of a second cavity of the film pasting device;

S102, interface the first cavity with the second cavity of the film pasting device, so that the flexible film layer disposed at the open end of the first cavity extrudes the functional film material, so that the functional film material is attached to the lens;

S103: turn on the illumination module of the film pasting device, so that the adhesive layer between the functional film material and the lens is cured under the irradiation of the illumination module, and adhere and fix the functional film material with the lens.

As shown in FIG. 4, before step S101, the method further includes: performing prepositioning on the lens 80 and the functional film material 90. Exemplarily, when the attaching surface of the lens 80 is a convex surface protruding toward the functional film material 90, the functional film material 90 may be pre-attached to the lens 80 by a mechanical arm or other tool, so that the relative position of the functional film material 90 and the lens 80 meets the requirement, for example, the central region of the lens 80 is pre-attached to the central region of the functional film material 90, so that the center of the functional film material 90 corresponds to the center of the lens 80. After pre-attaching, the edge of the functional film material 90 is in a tilted state with respect to the lens 80 without pressing with a roller or a pressing head or the like. Before the pre-attaching, as shown in FIG. 5 and FIG. 6, an adhesive layer 91 is disposed on a surface of the functional film material 90 facing the lens 80, and an adhesive layer 91 is disposed on a surface of one of the adjacent functional film materials 90, and at this time, the adhesive layer 91 is not irradiated by the illumination module 40.

When the attaching surface of the lens 80 is a concave surface recessed away from the functional film material 90 (not shown), the functional film material 90 may be pre-attached to the lens 80 by a mechanical arm or other tool, so that the relative position of the functional film material 90 and the lens 80 meets the requirements. When the functional film material 90 is pre-attached to the lens 80, the functional film material 90 may be pre-attached to the edge of the lens 80. In addition, before the pre-attaching, an adhesive layer 91 is disposed on a surface of the functional film material 90 facing the lens 80, and an adhesive layer 91 is disposed on a surface of one of the adjacent functional film materials 90, and at this time, the adhesive layer 91 is not irradiated by the illumination module 40.

In order to improve the positioning reliability of the lens 80 having the concave surface as the attaching surface, the positioning film layer 92 may be disposed on a side of the functional film material 90 facing away from the lens 80. In this way, in the prepositioning process, the positioning film layer 92 needs to be pre-attached to the functional film material 90 through mechanical arm or other tool, so that the relative position of the functional film material 90 and the positioning film layer 92 meets the requirements. Exemplarily, the relative position of positioning film layer 92, the functional film material 90 and the lens 80 meets requirements may include: the centers of the positioning film layer 92, the functional film material 90, and the lens 80 correspond to each other. In addition, an adhesive structure made of other adhesive material is disposed on the surface of the positioning film layer 92 facing the functional film material 90, which facilitates subsequent removal of the positioning film layer 92.

In step S101, as shown in FIG. 4 or FIG. 8, when the attaching surface of the lens 80 is a convex surface protruding toward the functional film material 90, the lens 80 and the functional film material 90 being prepositioned are placed in the bearing area 21 of the second cavity 20, and at this time, the surface of the bearing area 21 facing the first cavity 10 may be planar or convex or concave.

As shown in FIG. 14, when the attaching surface of the lens 80 is a concave surface recessed away from the functional film material 90, the lens 80, the functional film material 90 and the positioning film layer 92 being prepositioned are placed in the avoidance groove 25 of the second cavity 20 located in the bearing area 21, and the through hole 92a provided in the positioning film layer 92 can match with the positioning portion 26 on the second cavity 20. In other examples, the portion of the second cavity 20 located in the bearing area may not be provided with the avoidance groove, and the second cavity is not provided with the positioning portion, and the lens 80 and the second cavity 20 may be relatively fixed in other manners.

In step S102, the flexible film layer 30 can deform under the action of external force, and the force generated by the deformation can act on the functional film material 90 to extrude the functional film material 90, so that the functional film material 90 gradually becomes a curved surface matched with the attaching surface of the lens 80.

As shown in FIG. 4 or FIG. 8, when the attaching surface of the lens 80 is a convex surface protruding toward the functional film material 90, in the functional film material 90 and the lens 80 being prepositioned, the edge of the functional film material 90 is in a tilted state with respect to the lens 80. In the interfacing process, when the distance between the first cavity 10 and the second cavity 20 is reduced to a certain degree, the flexible film layer 30 can be in contact with the functional film material 90 on the upper side of the lens 80, and as the distance between the first cavity 10 and the second cavity 20 continues to decrease, the flexible film layer 30 can deform under the action of the lens 80 and the functional film material 90 and generate an acting force acting on the functional film material 90 to extrude the functional film material 90, so that the functional film material 90 gradually becomes a convex surface matches the attaching surface of the lens 80 until the functional film material 90 is completely attached to the lens 80.

As shown in FIG. 14, when the attaching surface of the lens 80 is a concave surface recessed away from the functional film material 90, during the interfacing process, the positioning hole 10a on the first cavity 10 needs to match with the part of positioning portion 26 on the second cavity 20 extend out of the through hole 92a. After interfaced in place, the flexible film layer 30 can deform and generate acting force under the acting force generated by the pressure difference between the upper pressure and the lower pressure, and the acting force acts on the functional film material 90 to extrude the functional film material 90, so that the functional film material 90 gradually becomes a concave surface matched with the attaching surface of the lens 80 until the functional film material 90 is completely attached to the lens 80. In other examples, the flexible film layer 30 may also deform under the force applied by other structural members and generate a force.

In step S103, after the functional film material 90 and the lens 80 are attached and the flexible film layer 30 is extruded for a certain time, the illumination module 40 may be turned on, so that the light emitted by the illumination module 40 can irradiate the photoinitiator in the adhesive layer 91, so that the adhesive layer 91 is cured, and the functional film material 90 is adhered and fixed with the lens 80.

In the film pasting method provided in this embodiment, the lens 80 and the functional film material 90 being prepositioned are placed on the bearing area 21 of the second cavity 20 of the film pasting device, the first cavity 10 of the film pasting device in the bearing area 21 is interfaced with the second cavity 20, the flexible film layer 30 disposed at the open end of the first cavity 10 and the second cavity 20 enclose a bearing space, the flexible film layer 30 extrudes the functional film material 90 in the bearing space, so that the functional film material 90 is attached to the lens 80, the illumination module 40 of the film pasting device in the bearing area 21 is turned on, the adhesive layer 91 between the functional film material 90 and the lens 80 is cured under the irradiation of the illumination module 40 in the bearing area 21, and the functional film material 90 is adhered and fixed with the lens 80. Therefore, the curved surface film pasting layer can be achieved without hot bending forming, the problems of large precision control difficulty, poor matching property of the functional film material 90 and the lens 80 surface type caused by the rebound phenomenon after hot bending forming are avoided, the method is easy to implement, the product yield is improved, and the process difficulty of curved surface attaching is reduced.

Referring to FIG. 16, the present embodiment further provides a film pasting method, including:

S201, placing a lens and a functional film material being prepositioned in a bearing area of a second cavity of the film pasting device;

S202, interfacing the first cavity and the second cavity of the film pasting device, so that the flexible film layer disposed at the open end of the first cavity and the second cavity enclose a bearing space, and turning on the vacuum pump of the film pasting device, so that the vacuum pump vacuumizes the bearing space through the airflow channel formed in the second cavity, so that the flexible film layer extrudes the functional film material in the bearing space, so that the functional film material is attached to the lens;

S203, turning on the illumination module of the film pasting device, so that the adhesive layer between the functional film material and the lens is cured under the irradiation of the illumination module, and adhere and fix the functional film material with the lens.

The implementation process of step S201 and step S203 may be the same as the implementation processes of step S101 and step S103, and details are not described herein again. In addition, the implementation process of step S202 is similar to the implementation process of step S102, and the similar details are not described herein again.

In step S202, as shown in FIG. 8, after the first cavity 10 of the film pasting device in the bearing area 21 is interfaced with the second cavity 20, when the attaching surface of the lens 80 is a convex surface protruding toward the functional film material 90, in a process of interfacing the first cavity 10 and the second cavity 20, as the distance between the first cavity 10 and the second cavity 20 continues to decrease, the flexible film layer 30 can deform under the action of the lens 80 and the functional film material 90 and generate a force acting on the functional film material 90 to extrudes the functional film material 90, so that the functional film material 90 gradually becomes a convex surface matched with the attaching surface of the lens 80. After the first cavity 10 and the second cavity 20 are interfaced in place, the vacuum pump 50 is controlled to turn on and vacuumize the bearing space enclosed by the flexible film layer 30 and the second cavity 20, so that a pressure difference is formed between the space above the flexible film layer 30 and the space below the flexible film layer 30, so that the flexible film layer 30 contracts and further extrudes the functional film material 90, and the air between the functional film material 90 and the lens 80 is discharged, so that the functional film material 90 and the lens 80 are tightly attached, and the problem of wrinkling of the film material and warping of the film material edge can be further improved.

As shown in FIG. 14, when the attaching surface of the lens 80 is a concave surface recessed away from the functional film material 90, after the first cavity 10 and the second cavity 20 are interfaced in place, the vacuum pump 50 is controlled to turn on and vacuumize the bearing space enclosed by the flexible film layer 30 and the second cavity 20, so that a pressure difference is formed between the space above the flexible film layer 30 and the space below the flexible film layer 30, the flexible film layer 30 contracts and extrudes the functional film material 90, and the air between the functional film material 90 and the lens 80 is discharged, so that the functional film material 90 gradually becomes a concave surface matched with the attaching surface of the lens 80 until the functional film material 90 is tightly attached to the lens 80, and the problem of wrinkling of the film material and warping of the film material edge can be effectively improved.

When the attaching surface of the lens 80 is a concave surface recessed away from the functional film material 90, the lens 80 needs to match with the avoidance groove 25 on the second cavity 20, and the positioning film layer 92 needs to match with the second cavity 20 to improve the positioning reliability, and the following describes a case in which the attaching surface of the lens 80 is a concave surface.

In step S101 or step S201, the lens 80, the functional film material 90 being prepositioned and the positioning film layer 92 may be placed in the avoidance groove 25 of the bearing area 21 of the second cavity 20 of the film pasting device, and the through hole 92a on the positioning film layer 92 matches with the positioning portion 26 provided on the second cavity 20.

In step S102 or step S202, during interfacing, and before the flexible film layer at the open end of the first cavity of the bearing area 21 and the second cavity of the bearing area 21 enclose the bearing space, the method further includes:
placing the first cavity of the film pasting device in the bearing area 21 on the second cavity, so that the positioning hole formed in the first cavity of the bearing area 21 can match with a part of the through hole of the positioning portion protruding out of the bearing area 21.

After step S103 or step S203, the method further includes:
removing the positioning film layer in the bearing area 21 from the functional film in the bearing area 21.

The following describes an implementation process of the film pasting device and the film pasting method provided in this embodiment.

1) Referring to FIG. 1 to FIG. 6, when the attaching surface of the lens 80 is a convex surface protruding toward the functional film material 90, and the film pasting device is not provided with the vacuum pump 50:

The lens 80 and the functional film material 90 are prepositioned, and the lens 80 and the functional film material 90 being prepositioned are placed on the bearing area 21 of the second cavity 20, and at this time, the edge of the functional film material 90 is in a tilted state with respect to the lens 80.

Interface the first cavity 10 and the second cavity 20, during interfacing process, when the distance between the first cavity 10 and the second cavity 20 is reduced to a certain degree, the flexible film layer 30 can be in contact with the functional film material 90 on the upper side of the lens 80, and as the distance between the first cavity 10 and the second cavity 20 continues to decrease, the flexible film layer 30 can deform under the extrusion action of the lens 80 and the functional film material 90 and generate tension, and the tension is used for the functional film material 90 to extrude the functional film material 90, so that the functional film material 90 gradually becomes a convex surface matched with the attaching surface of the lens 80 until the functional film material 90 is completely attached to the lens 80. After the first cavity 10 and the second cavity 20 are interfaced in place, that is, after the enclosed space is enclosed by the second cavity 20 and the flexible film layer 30, the preset time is maintained, and the preset time may be greater than or equal to 5 seconds.

After the maintained time reaches the preset time, the illumination module 40 is controlled to be turned on, the light emitted by the illumination module 40 can irradiate the photoinitiator in the adhesive layer 91, and the adhesive layer 91 is cured to adhere and fix the functional film material 90 with the lens 80.

2) Referring to FIG. 7 to FIG. 8, when the attaching surface of the lens 80 is a convex surface protruding toward the functional film material 90, and the film pasting device is provided with the vacuum pump 50:

The lens 80 and the functional film material 90 are prepositioned, and the lens 80 and the functional film material 90 being prepositioned are placed into the bearing area 21 of the second cavity 20, and at this time, the edge of the functional film material 90 is in a tilted state with respect to the lens 80.

Interface the first cavity 10 and the second cavity 20, during interfacing process, when the distance between the first cavity 10 and the second cavity 20 is reduced to a certain degree, the flexible film layer 30 can make contact with the functional film material 90 on the upper side of the lens 80, and as the distance between the first cavity 10 and the second cavity 20 continues to decrease, the flexible film layer 30 can deform under the extrusion action of the lens 80 and the functional film material 90 and generate tension, and the tension is used for the functional film material 90 to extrude the functional film material 90, so that the functional film material 90 gradually becomes a convex surface matched with the attaching surface of the lens 80.

After the first cavity 10 and the second cavity 20 are interfaced in place, the vacuum pump 50 is controlled to turn on and vacuumize the bearing space enclosed by the flexible film layer 30 and the second cavity 20, so that a pressure difference is formed between the space above the flexible film layer 30 and the space below the flexible film layer 30, so that the flexible film layer 30 contracts and further extrudes the functional film material 90, and the air between the functional film material 90 and the lens 80 is discharged, so that the functional film material 90 is tightly attached to the lens 80. After vacuumizing, the preset time is maintained, and the preset time may be greater than or equal to 5 seconds;

After the maintained time reaches the preset time, the illumination module 40 is controlled to be turned on, the light emitted by the illumination module 40 can irradiate the photoinitiator in the adhesive layer 91, and the adhesive layer 91 is cured to adhere and fix the functional film material 90 with the lens 80.

3) Referring to FIG. 9 to FIG. 14, when the attaching surface of the lens 80 is a concave surface recessed away from the functional film material 90, and the film pasting device is provided with the vacuum pump 50:

The positioning film layer 92, the functional film material 90 and the lens 80 are prepositioned, the lens 80, the functional film material 90 and the positioning film layer 92 being prepositioned are placed into the avoidance groove 25 of the bearing area 21 of the second cavity 20, so that the through hole 92a on the positioning film layer 92 matches with the positioning portion 26 provided on the second cavity 20, and at this time, the functional film material 90 and the positioning film layer 92 are in a planar state;

The first cavity 10 is interfaced with the second cavity 20, and the first cavity 10 of the film pasting device in the bearing area 21 may be placed on the second cavity 20, so that the positioning hole 10a provided in the first cavity 10 is aligned with a portion of the positioning portion 26 extending out of the through hole 92a of the bearing area 21, and when the positioning portion 26 is inserted into the positioning hole 10a, and the positioning film layer 92 and the second cavity 20 enclose a relatively closed space, the first cavity 10 and the second cavity 20 are interfaced in place.

After the first cavity 10 and the second cavity 20 are interfaced in place, the vacuum pump 50 is controlled to turn on and vacuumize the bearing space enclosed by the flexible film layer 30 and the second cavity 20, so that a pressure difference is formed between the space above the flexible film layer 30 and the space below the flexible film layer 30, the flexible film layer 30 contracts and extrudes the functional film material 90, and the air between the functional film material 90 and the lens 80 is discharged, so that the functional film material 90 gradually becomes a concave surface matched with the attaching surface of the lens 80 until the functional film material 90 is tightly attached to the lens 80, and after vacuumizing, the preset time is maintained, and the preset time may be greater than or equal to 5 seconds;

After the maintained time reaches the preset time, the illumination module 40 is controlled to be turned on, the light emitted by the illumination module 40 can irradiate the photoinitiator in the adhesive layer 91, and the adhesive layer 91 is cured to adhere and fix the functional film material 90 with the lens 80.

Remove the positioning film layer 92 in the bearing area 21 from the functional film material 90.

The film pasting device and the film pasting method provided by the embodiment are not limited by the thickness and the surface type of the lens, have a larger application range, and can be suitable for more scenes; the lens and the functional film material do not need to be subjected to hot bending forming, the rebound phenomenon after hot bending forming can be avoided, the preparation precision of the lens and the functional film material can be improved, and the problems of wrinkling and edge warping of the functional film material can be solved; in addition, the acting force is uniformly transferred to the functional film material through deformation of the flexible film layer, so that the stretching ratio of the functional film material is reduced, the stress of the attached functional film material is small, the optical axis of the optical module is basically unchanged, and the problem that the wavy line, the orange peel and the optical axis are not controllable after stretching is solved.

It should be understood that the steps recited in the method embodiments of the disclosure may be performed in different orders, and/or in parallel. Further, the method embodiments may include additional steps and/or omit performing the illustrated steps. The scope of the disclosure is not limited in this respect.

As used herein, the term “comprising” and deformation thereof are open-ended, i.e., “including but not limited to”. The term “based on” is “based at least in part on”. The term “one embodiment” means “at least one embodiment”; the term “another embodiment” means “at least one further embodiment”; the term “some embodiments” means “at least some embodiments”. The relevant definition of other terms will be given below.

It should be noted that concept concepts such as “first” and “second” mentioned in the disclosure are merely used to distinguish different apparatuses, modules, or units, and are not intended to limit the order of functions performed by the apparatuses, modules, or units or the mutual dependency relationship.

It should be noted that the modification of “a” and “a plurality” mentioned in the disclosure is illustrative and not limiting, and those skilled in the art should understand that “one or more” should be understood unless the context clearly indicates otherwise.

The foregoing is only a specific embodiment of the disclosure, but the protection scope of the disclosure is not limited thereto, and any person skilled in the art may easily conceive of variations or replacements within the technical scope of the disclosure, and should be covered within the protection scope of the disclosure. Therefore, the protection scope of the disclosure should be based on the protection scope of the claims.

I/We claim:

1. A film pasting device, comprising:
a first cavity;
a second cavity being capable of interfacing with the first cavity and having a bearing area configured to bear a lens and a functional film material being prepositioned;
a flexible film layer disposed at an open end of the first cavity and configured to deform under an external force and extrude the functional film material, so that the functional film material is attached to the lens;
an illumination module configured to irradiate the functional film material, so that an adhesive layer between the functional film material and the lens is cured, and the functional film material is adhered and fixed to the lens.

2. The film pasting device according to claim 1, wherein when the first cavity and the second cavity are in an interfaced state, the flexible film layer and the second cavity are capable of enclosing a bearing space, and the lens and the functional film material beared by the bearing area are located within the bearing space;
the second cavity is provided with an airflow channel, and the airflow channel is communicated with the bearing space;
the film pasting device further comprises a vacuum pump, the vacuum pump is communicated with the airflow channel, and the vacuum pump is configured to vacuumize the bearing space.

3. The film pasting device according to claim 2, wherein the airflow channel comprises air vents and an airflow convergence hole;
wherein the air vents are communicated with the bearing space; the air vents include a plurality of air vents spaced and uniformly distributed;
the airflow convergence hole is located at an end of the air vents facing away from the bearing space, and the airflow convergence hole is configured to communicate the plurality of air vents with the vacuum pump.

4. The film pasting device according to claim 1, wherein an end of the second cavity facing the interfaced first cavity is provided with a groove communicated with the bearing space, and at least a part of the groove is located at a periphery of the bearing area;
wherein the bearing space is enclosed by the flexible film layer and the second cavity;
the bearing area is a region where an orthographic projection of the lens and the functional film material on an end surface of the second cavity facing the interfaced end is located.

5. The film pasting device according to claim 4, wherein an end of the airflow channel communicated with the vacuum pump is communicated with the groove.

6. The film pasting device according to claim 1, wherein the illumination module is disposed within the first cavity or disposed within the second cavity;
or, an irradiation area of the illumination module at least covers the bearing area;
or, the illumination module comprises an ultraviolet light irradiation module.

7. The film pasting device according to claim 1, wherein when the first cavity and the second cavity are in an interfaced state, a part of the flexible film layer is sandwiched between an interfaced surface of the first cavity and an interfaced area of the second cavity; wherein the interfaced area of the second cavity is located at a periphery of the bearing area.

8. The film pasting device according to claim 1, wherein an end of the second cavity facing the interfaced first cavity is provided with an avoidance groove, the avoidance groove is at least partially located in the bearing area, and a shape of the avoidance groove matches with a shape of the lens; wherein the lens is recessed in a direction away from the functional film material.

9. The film pasting device according to claim 8, wherein an end of the second cavity facing the first cavity further has an interfaced area, and the interfaced area is located at a periphery of the bearing area;
the second cavity is provided with at least one positioning portion extending toward the first cavity, and the positioning portion is located in the interfaced area;
an interfaced area of the first cavity facing the second cavity is provided with a positioning hole matched with the positioning portion;
wherein a side of the functional film material facing away from the lens is provided with a positioning film layer, the ductility of the positioning film layer is higher than that of the functional film material, the positioning film layer is provided with a through hole matched with the positioning portion, and the through hole is located at a part of the positioning film layer protruding out of the functional film material in a direction perpendicular to the thickness of the positioning film layer.

10. The film pasting device according to claim 1, wherein the functional film material comprises a plurality of functional film materials, and the two adjacent functional film materials are adhered and fixed by the adhesive layer;
wherein the functional film material comprises at least one of: a polarizing film layer, a reflective film layer, and a quarter-wave plate.

11. A film pasting method, comprising:
placing a lens and a functional film material being prepositioned in a bearing area of a second cavity of a film pasting device;
interfacing a first cavity and the second cavity of the film pasting device, so that a flexible film layer disposed at an open end of the first cavity extrudes the functional film material, so that the functional film material is attached to the lens;
turning on an illumination module of the film pasting device, so that an adhesive layer between the functional film material and the lens is cured under the irradiation of the illumination module, and the functional film material is adhered and fixed to the lens.

12. The film pasting method according to claim 11, wherein after interfacing the first cavity and the second cavity of the film pasting device, the method further comprises:
turning on a vacuum pump of the film pasting device, so that the vacuum pump vacuumizes the bearing space through an airflow channel formed in the second cavity; wherein when the first cavity and the second cavity are in an interfaced state, the flexible film layer is capable of enclosing the bearing space with the second cavity, and the lens and the functional film material beared by the bearing area are located within the bearing space.

13. The film pasting method according to claim 11, wherein when an attaching surface of the lens is a concave surface recessed away from the functional film material:
the placing a lens and a functional film material being prepositioned in a bearing area of a second cavity of a film pasting device comprises:
placing the lens, the functional film material being prepositioned and a positioning film layer in an avoidance groove of the second cavity of the film pasting device, so that a through hole formed in the positioning film layer matches with a positioning portion disposed on the second cavity; wherein the positioning film layer is located on a side of the functional film material facing away from the lens;
interfacing the first cavity and the second cavity of the film pasting device comprises:
placing the first cavity of the film pasting device on the second cavity, so that a positioning hole formed in the first cavity matches with a part of the positioning portion protruding out of the through hole;
after the functional film material is adhered and fixed to the lens, the method further comprises:
removing the positioning film layer from the functional film material.

14. The film pasting method according to claim 12, wherein the airflow channel comprises air vents and an airflow convergence hole;
wherein the air vents are communicated with the bearing space; the air vents include a plurality of air vents spaced and uniformly distributed;
the airflow convergence hole is located at an end of the air vents facing away from the bearing space, and the airflow convergence hole is configured to communicate the plurality of air vents with the vacuum pump.

15. The film pasting method according to claim 11, wherein an end of the second cavity facing the interfaced first cavity is provided with a groove communicated with the bearing space, and at least a part of the groove is located at a periphery of the bearing area;
wherein the bearing space is enclosed by the flexible film layer and the second cavity;
the bearing area is a region where an orthographic projection of the lens and the functional film material on an end surface of the second cavity facing the interfaced end is located.

16. The film pasting method according to claim 15, wherein an end of the airflow channel communicated with the vacuum pump is communicated with the groove.

17. The film pasting method according to claim 11, wherein the illumination module is disposed within the first cavity or disposed within the second cavity;
or, an irradiation area of the illumination module at least covers the bearing area;
or, the illumination module comprises an ultraviolet light irradiation module.

18. The film pasting method according to claim 11, wherein when the first cavity and the second cavity are in an interfaced state, a part of the flexible film layer is sandwiched between an interfaced surface of the first cavity and an interfaced area of the second cavity; wherein the interfaced area of the second cavity is located at a periphery of the bearing area.

19. The film pasting method according to claim 11, wherein an end of the second cavity facing the interfaced first cavity is provided with an avoidance groove, the avoidance groove is at least partially located in the bearing area, and a shape of the avoidance groove matches with a shape of the lens; wherein the lens is recessed in a direction away from the functional film material.

20. The film pasting method according to claim 11, wherein the functional film material comprises a plurality of functional film materials, and the two adjacent functional film materials are adhered and fixed by the adhesive layer;
wherein the functional film material comprises at least one of: a polarizing film layer, a reflective film layer, and a quarter-wave plate.
